(19) United States
(12) Patent Application Publication
(10) Pub. No.: US 2025/0123424 A1
(43) Pub. Date: Apr. 17, 2025

(54) OPTICAL COMPONENT, FRONT LIGHT MODULE AND REFLECTIVE DISPLAY

(71) Applicant: Radiant Opto-Electronics Corporation, Kaohsiung City (TW)

(72) Inventors: Wei-Hsuan CHEN, Kaohsiung City (TW); Yung-Hui TAI, Kaohsiung City (TW); Yuan-Chen CHUNG, Kaohsiung City (TW)

(21) Appl. No.: 18/912,586

(22) Filed: Oct. 11, 2024

(30) Foreign Application Priority Data
Oct. 12, 2023 (CN) 202311321405.0

(51) Int. Cl. G02B 1/12; G02B 1/11

(52) U.S. Cl. CPC G02B 1/12; G02B 1/11

(57) ABSTRACT

A light guide film comprises a base material layer, an upper ultraviolet adhesive layer, a lower ultraviolet adhesive layer, two optical adhesive layers and a light incident microstructure unit. The base material layer has a light incident surface. The upper ultraviolet adhesive layer is disposed above the base material layer. The lower ultraviolet adhesive layer is disposed below the base material layer. The two optical adhesive layers are disposed above the upper ultraviolet adhesive layer and below the lower ultraviolet adhesive layer, respectively. The light incident microstructure unit has a first microstructure region disposed on the light incident surface of the base material layer.

### RELATED APPLICATIONS

This application claims priority to China Patent Application Serial Number 202311321405.0, filed on Oct. 12, 2023, the content of which are incorporated herein by reference in their entireties.

### BACKGROUND

### Technical field

The present disclosure relates to a light guide film. More particular, the present disclosure relates to the light guide film which can reduced the light halation of light incident, and also relates to the front light module and the reflective display including this light guide film.

### Description of Related Art

In order to meet the demand for the thinning design of the front light module of the electronic book reader (e-book reader), the thinner light guide plates are used. However, the thickness of the LED is larger than the thickness of the light guide plate. Thus, in order to improve the light coupling efficiency and solve problems, such as bright spots, a thicker light incident part is applied to the light guide plate. Further, the light incident microstructures are disposed near to the light source to solve the problem of LED hotspot.

However, when the light ray enters the light guide plate from the light incident microstructures, the variation of the thickness of the light incident microstructures leads to the refraction and the reflection of the light ray. Thus, the probability for breaching the rule of the total internal reflection increases so as to increase the light halation and cause poor appearance of the light emitting surface. Furthermore, in order to improve the issue of the light poor intake, the shielding region should be increased, so that the front light module has more ineffective regions and is unable to meet the narrow bezel requirement.

Therefore, it is necessary to provide a light guide film to solve aforementioned problems.

### SUMMARY

Accordingly, the disclosure provides a light guide film, where the light incident microstructure is only disposed on the light incident surface of the base material layer so as to reduce the probability for breaching the rule of the total internal reflection.

An embodiment of the disclosure provides a front light module including the aforementioned light guide film so as to reduce the light halation and improve the appearance of the light emitting surface.

An embodiment of the disclosure provides a reflective display including the aforementioned front light module as to meet the demand for narrow bezel module.

At least one embodiment of the disclosure provides a light guide film. The light guide film includes a base material layer including a light incident surface, an upper ultraviolet adhesive layer disposed above the base material layer, a lower ultraviolet adhesive layer disposed below the base material layer, two optical adhesive layers disposed above the upper ultraviolet adhesive layer and below the lower ultraviolet adhesive layer respectively and a light incident microstructure unit including a first microstructure region and disposed on the light incident surface of the base material layer.

At least in one embodiment of the disclosure, the light incident microstructure unit further includes a second microstructure region disposed on two end surfaces of the upper ultraviolet adhesive layer and the lower ultraviolet adhesive layer respectively and near to the light incident surface of the base material layer.

At least in one embodiment of the disclosure, the light incident microstructure unit increases a plurality of microstructures. Each of the microstructures within the first microstructure region has a first depth, and each of the microstructures within the second microstructure region has a second depth. The first depth is larger than the second depth.

At least in one embodiment of the disclosure, a refractive index of the base material layer is larger than a refractive index of the lower ultraviolet adhesive layer, and a difference in between is D1.

At least in one embodiment of the disclosure, an absolute difference between the refractive index of the lower ultraviolet adhesive layer and a refractive index of the optical adhesive layer near to the lower ultraviolet adhesive layer is D2, and the absolute difference satisfies the inequality: 0≤D2<D1.

At least in one embodiment of the disclosure, a refractive index of the base material layer is smaller than a refractive index of the upper ultraviolet adhesive layer.

At least in one embodiment of the disclosure, a refractive index of the base material layer is equal to a refractive index of the upper ultraviolet adhesive layer.

At least in one embodiment of the disclosure, a refractive index of the lower ultraviolet adhesive layer is smaller than a refractive index of the upper ultraviolet adhesive layer.

At least in one embodiment of the disclosure, the lower ultraviolet adhesive layer includes an inclined part and a flat part. The inclined part is near to the light incident surface of the base material layer, and the flat part extends from the inclined part in a direction away from the light incident surface of the base material layer.

At least one embodiment of the disclosure provides a front light module including the light guide film and a light emitting unit. The upper ultraviolet adhesive layer of the light guide film includes a plurality of reflective microstructures, and the light emitting unit is disposed opposite to a light incident side of light guide film.

At least one embodiment of the disclosure provides a reflective display including the front light module, an optical component disposed above the light guide film and a reflective display panel disposed below the light guide film.

At least in one embodiment of the disclosure, the optical component is a touch sensor.

Accordingly, light guide film, the front light module and the reflective display of the disclosure have the features as follow. Since the light incident microstructure unit is disposed on the light incident surface of the base material layer, the light incident microstructure unit is unnecessary to be disposed on the upper ultraviolet adhesive layer and the lower ultraviolet adhesive layer. The design of locally light incident microstructure unit is able to reduce the probability for breaching the rule of the total internal reflection at the light incident surface near to the base material layer so as to locally adjust the probability for changing the light path in the light incident region and the light halation is prevented. In addition, the light incident microstructure unit may solve the problem of LED hotspot so as to meet demands for narrow bezel module.

### BRIEF DESCRIPTION OF THE DRAWINGS

To illustrate more clearly the aforementioned and the other objects, features, merits, and embodiments of the present disclosure, the description of the accompanying figures are as follows:

FIG. 1 illustrates a cross-sectional view of the light guide film in accordance with the first embodiment of the present disclosure;

FIG. 2 illustrates a top view of the base material layer of the light guide film in accordance with the first embodiment of the present disclosure;

FIG. 3 illustrates a cross-sectional view of the light guide film in accordance with the second embodiment of the present disclosure;

FIG. 4 illustrates a cross-sectional view of the front light module in accordance with the first embodiment of the present disclosure; and

FIG. 5 illustrates a schematic view of the reflective display in accordance with the first embodiment of the present disclosure.

### DETAILED DESCRIPTION

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the following description, the dimensions (such as lengths, widths and thicknesses) of components (such as layers, films, substrates and regions) in the drawings are enlarged not-to-scale, and the number of components may be reduced in order to clarify the technical features of the disclosure. Therefore, the following illustrations and explanations are not limited to the number of components, the number of components, the dimensions and the shapes of components, and the deviation of size and shape caused by the practical procedures or tolerances are included. For example, a flat surface shown in drawings may have rough and/or non-linear features, while angles shown in drawings may be circular. As a result, the drawings of components shown in the disclosure are mainly for illustration and not intended to accurately depict the real shapes of the components, nor are intended to limit the scope of the claimed content of the disclosure.

Further, when a number or a range of numbers is described with “about,” “approximate,” “substantially,” and the like, the term is intended to encompass numbers that are within a reasonable range considering variations that inherently arise during manufacturing as understood by one of ordinary skill in the art. In addition, the number or range of numbers encompasses a reasonable range including the number described, such as within +/−5%, +/−3% or +/−1% of the number described, based on known manufacturing tolerances associated with manufacturing a feature having a characteristic associated with the number. The words of deviations such as “about,” “approximate,” “substantially,” and the like are chosen in accordance with the optical properties, etching properties, mechanical properties or other properties. The words of deviations used in the optical properties, etching properties, mechanical properties or other properties are not chosen with a single standard.

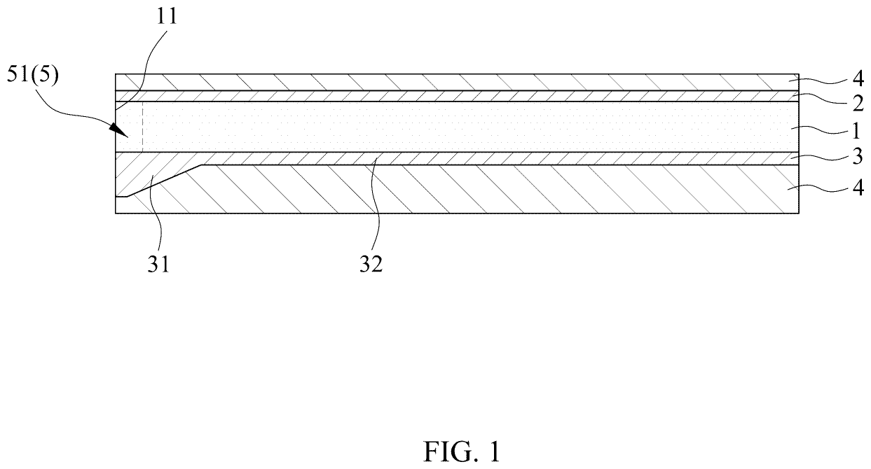

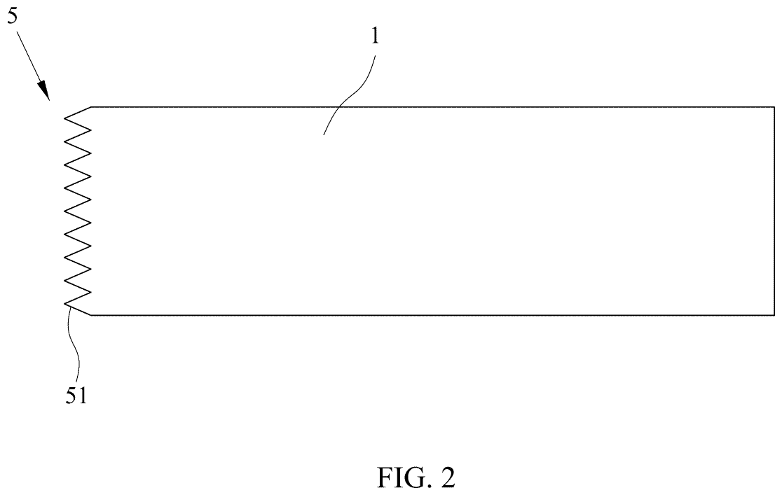

Referring to FIG. 1 which illustrates a cross-sectional view of the first embodiment of the present disclosure, the light guide film includes a base material layer 1, an upper ultraviolet adhesive layer 2, a lower ultraviolet adhesive layer 3, two optical adhesive layers 4 and a light incident microstructure unit 5. The base material layer 1 includes a light incident surface 11. The upper ultraviolet adhesive layer 2 is disposed above the base material layer 1, while the lower ultraviolet adhesive layer 3 is disposed below the base material layer 1. The optical adhesive layers 4 are disposed above the upper ultraviolet adhesive layer 2 and below the lower ultraviolet adhesive layer 3 respectively. Referring to FIG. 2, the light incident microstructure unit 5 includes a first microstructure region 51 which disposed on the light incident surface 11 of the base material layer 1.

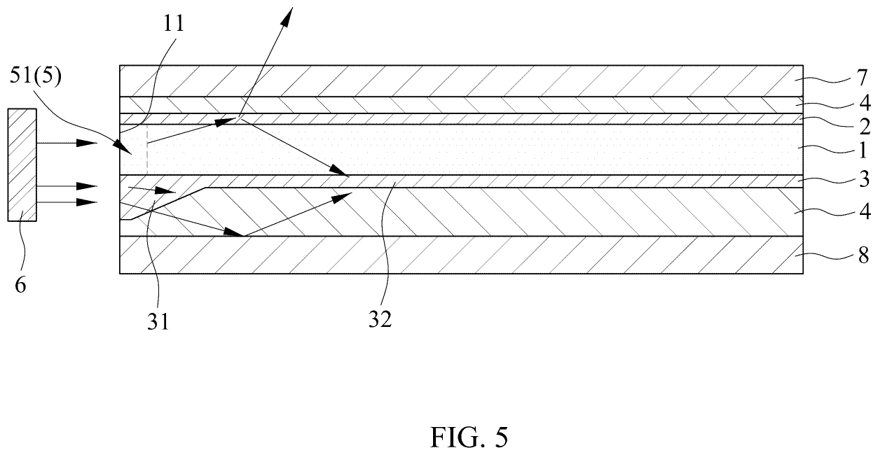

Accordingly, referring to FIG. 5, the light incident microstructure unit 5 is disposed on the light incident surface 11 of the base material layer 1, so that the light incident microstructure unit 5 is unnecessary to be disposed on the upper ultraviolet adhesive layer 2 and the lower ultraviolet adhesive layer 3. Base on aforementioned design of locally light incident microstructure unit, the light ray enters the lower ultraviolet adhesive layer 3 directly instead of passing through the light incident microstructure unit 5 before entering the lower ultraviolet adhesive layer 3. Thus, less refraction and reflection of the light ray occur so as to reduce the probability for breaching the rule of the total internal reflection at the light incident surface 11 near to the base material layer 1. As a result, the light halation is decreased, and the appearance of the light emitting surface is improved. Furthermore, the light incident microstructure unit 5 can solve the problem of LED hotspot so as to meet demands for narrow bezel module.

The upper ultraviolet adhesive layer 2 and the lower ultraviolet adhesive layer 3 are curable by ultraviolet light (UV light), but the base material layer 1 is curable by heat. Thus, compared to the base material layer 1, the upper ultraviolet adhesive layer 2 and the lower ultraviolet adhesive layer 3 are more difficult to be cured but restored the original state after being cooled down from thermal molding, so that the light incident microstructure unit 5 is difficult to be formed by thermal imprinting. On the contrary, the base material layer 1 is cured after being cooled down from thermal molding, so as to form and retain the light incident microstructure unit 5.

Specifically, the refractive index of the lower ultraviolet adhesive layer 3 is smaller than the refractive index of the upper ultraviolet adhesive layer 2. The refractive index of the base material layer 1 is larger than the refractive index of the lower ultraviolet adhesive layer 3 but smaller than or equal to the refractive index of the upper ultraviolet adhesive layer 2. As a result, the light ray which is reflected by the lower ultraviolet adhesive layer 3 and enters the base material layer 1 and the upper ultraviolet adhesive layer 2 incidents the optically denser medium from the optically thinner medium. The brightness can be increased by reducing the occurrence of the light ray to return the optically thinner medium.

In addition, the lower ultraviolet adhesive layer 3 are imprinting on the base material layer 1 by roller printing in general, so that the structures and the flaws of the roller are imprinted on the base material layer 1. Thus, those imprinted flaws have a negative effect on the light emitting surface. As a result, in the embodiment, the refractive index of the base material layer 1 is designed to be larger than the refractive index of the lower ultraviolet adhesive layer 3, while the difference in between is D1. Preferably, the solute difference between the refractive index of the lower ultraviolet adhesive layer 3 and the refractive index of the optical adhesive layer 4 near to the lower ultraviolet adhesive layer 3 is D2. The absolute difference satisfies the inequality: 0≤D2<D1.

Accordingly, the refractive index of the lower ultraviolet adhesive layer 3 is similar to the refractive index of the optical adhesive layer 4 near to the lower ultraviolet adhesive layer 3, so that the surficial flaws of the lower ultraviolet adhesive layer 3 is filled up with the optical adhesive layers 4 with a similar or an equal refractive index. Thus, the light ray travels as in the same medium without effect of the flaws. As a result, the light ray which is refracted toward the lower ultraviolet adhesive layer 3 is prone to passing through the lower ultraviolet adhesive layer 3 and the optical adhesive layers 4 and then reaching the display panel of the reflective display below the light guide film instead of being reflected to the base material layer 1 and exiting from the upper ultraviolet adhesive layer 2. Thus, the light ray which exits from the upper ultraviolet adhesive layer 2 is reduced so as to prevent the light halation.

Specifically, the lower ultraviolet adhesive layer 3 includes an inclined part 31 and a flat part 32, while the inclined part 31 is near to the light incident surface 11 of the base material layer 1. The flat part 32 extends from the inclined part 31 in a direction away from the light incident surface 11 of the base material layer 1. Accordingly, the thickness of the inclined part 31 is thicker than the thickness of the flat part 32 so as to increase the luminous flux entering the lower ultraviolet adhesive layer 3, and thereby improving the efficiency of optical coupling.

However, the inclined part 31 is prone to causing the light refraction and the light reflection which increase the probability for breaching the rule of the total internal reflection, thereby leading to the light halation. As a result, the light incident microstructure unit 5 is only formed on the base material layer 1 without extending to the upper ultraviolet adhesive layer 2 and the lower ultraviolet adhesive layer 3 so as to locally adjust the probability for changing the light path in the light incident region. Furthermore, the probability for breaching the rule of the total internal reflection is reduced, that is, the light ray will pass through the inclined part 31 rather than be reflected to the base material layer 1 and exit from the upper ultraviolet adhesive layer 2, so that the light halation is prevented.

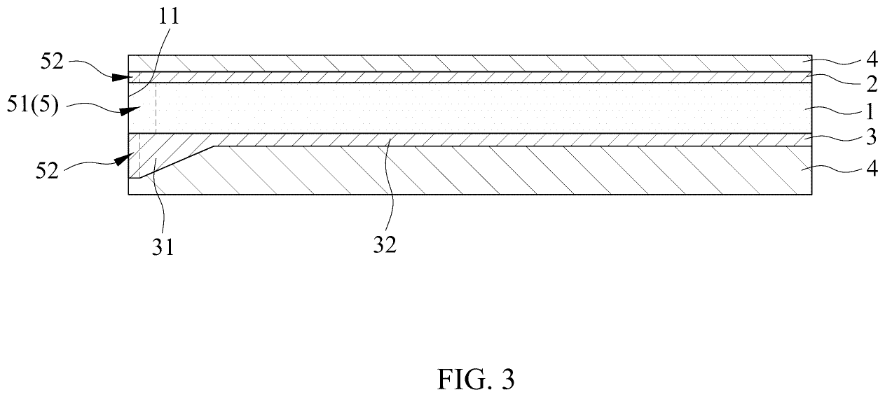

Referring to FIG. 3 which illustrates a cross-sectional view of the second embodiment of the light guide film in the present disclosure. Compared to the first embodiment, the difference is that the materials of the upper ultraviolet adhesive layer 2 and the lower ultraviolet adhesive layer 3 in the second embodiments are different from the first embodiment. That is, the thermo-curability of the upper ultraviolet adhesive layer 2 and the lower ultraviolet adhesive layer 3 is smaller than the base material layer 1. The light incident microstructure unit 5 further includes a second microstructure region 52 which is disposed on the end surfaces of the upper ultraviolet adhesive layer 2 and the lower ultraviolet adhesive layer 3 respectively and is near to the light incident surface 11 of the base material layer 1. Specifically, the first microstructure region 51 and the second microstructure region 52 which are near to the light incident surface 11 of the base material layer 1 are formed by thermal imprinting that imprints the microstructures on the light incident surface 11 of the base material layer 1 and on the end surfaces of the upper ultraviolet adhesive layer 2 and the lower ultraviolet adhesive layer 3 with a mold.

Accordingly, in order to prevent the light halation which is caused by breaching the rule of the total internal reflection due to the overall distribution of the light incident microstructure unit 5 on the light incident surface 11, the light incident microstructure unit 5 is designed to include a plurality of microstructures in the embodiment. Each of the microstructures in the first microstructure region 51 has the first depth, while each of the microstructures in the second microstructure region 52 has the second depth. Since the upper ultraviolet adhesive layer 2 and the lower ultraviolet adhesive layer 3 are curable by UV light but the base material layer 1 is curable by heat, the mold is easy to thermally imprint the microstructures on the base material layer 1 under heating. Thus, the microstructures which are thermally imprinted on the base material layer 1 are deeper. On the contrary, the microstructures which are thermally imprinted on the upper ultraviolet adhesive layer 2 and the lower ultraviolet adhesive layer 3 are shallower since the thermal curability of the upper ultraviolet adhesive layer 2 and the lower ultraviolet adhesive layer 3 is smaller than the base material layer 1. Thus, the first depth is larger than the second depth, so that the effect of adjustment for changing the light path in the light incident region at the base material layer 1 is larger than at the upper ultraviolet adhesive layer 2 and the lower ultraviolet adhesive layer 3. As a result, the probability for the light ray to be reflected to the base material layer 1 by the inclined part 31 and exit from the upper ultraviolet adhesive layer 2 is reduced, so that the light halation is prevented.

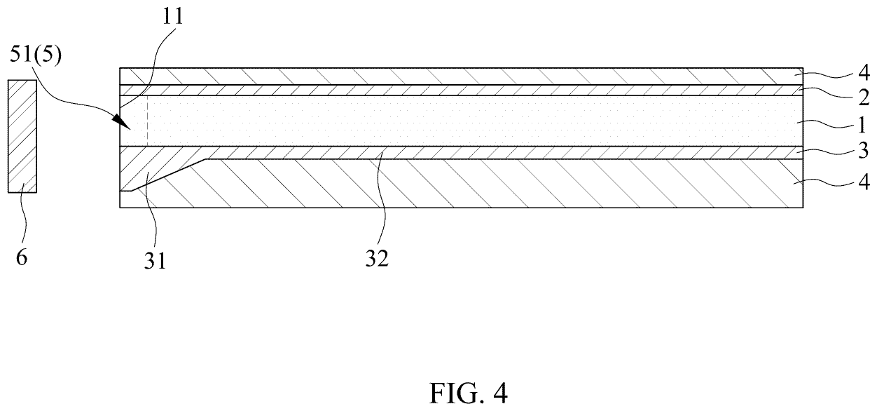

Referring to FIG. 4, the front light module of the present disclosure includes the aforementioned light guide film whose upper ultraviolet adhesive layer 2 includes a plurality of reflective microstructures and a light emitting unit 6 which is disposed opposite to a light incident side of light guide film.

Referring to FIG. 5, the reflective display of the present disclosure includes the aforementioned front light module, an optical component 7 which is disposed above the light guide film and a display panel 8 which is disposed below the light guide film. The reflective display is the e-book reader mentioned in the description of related art, while the optical component 7 is a touch sensor.

In conclusion, in the light guide film, the front light module and the reflective display of the present disclosure, since the upper ultraviolet adhesive layer and the lower ultraviolet adhesive layer are curable by UV light but the base material layer is curable by heat, the light incident microstructure unit is more difficult to be thermally imprinted on the upper ultraviolet adhesive layer and the lower ultraviolet adhesive layer than on the base material layer. Thus, the light incident microstructure unit is unnecessary to be disposed on the upper ultraviolet adhesive layer and the lower ultraviolet adhesive layer. The design of locally light incident microstructure unit is able to reduce the probability for breaching the rule of the total internal reflection at the light incident surface near to the base material layer so as to locally adjust the probability for changing the light path in the light incident region and the light halation is prevented. In addition, the refractive index of the base material layer is larger than the refractive index of the lower ultraviolet adhesive layer with the difference D1, and the absolute difference D2 between the refractive index of the lower ultraviolet adhesive layer and the refractive index of the optical adhesive layer near to the lower ultraviolet adhesive layer satisfies the inequality: 0≤D2<D1. Base on the reasons above, the light ray which is refracted toward the lower ultraviolet adhesive layer is prone to passing through the optical adhesive layer near to the lower ultraviolet adhesive layer and reaching the display panel so as to decrease the light exiting rate. Furthermore, the light incident microstructure unit may solve the problem of LED hotspot so as to meet demands for narrow bezel module. Therefore, the light guide film may be applied in the front light module of the e-book reader in order to meet demands for the color e-paper and the module thinning in the future.

Although the embodiments of the present disclosure have been disclosed as above in the embodiments, they are not intended to limit the embodiments of the present disclosure. Any person having ordinary skill in the art can make various changes and modifications without departing from the spirit and the scope of the embodiments of the present disclosure. Therefore, the protection scope of the embodiments of the present disclosure should be determined according to the scope of the appended claims.

What is claimed is:

1. A light guide film, comprising:
a base material layer comprising a light incident surface;
an upper ultraviolet adhesive layer disposed above the base material layer;
a lower ultraviolet adhesive layer disposed below the base material layer;
two optical adhesive layers disposed above the upper ultraviolet adhesive layer and below the lower ultraviolet adhesive layer respectively; and
a light incident microstructure unit comprising a first microstructure region and disposed on the light incident surface of the base material layer.

2. The light guide film of claim 1, wherein the light incident microstructure unit further comprises:
a second microstructure region disposed on two end surfaces of the upper ultraviolet adhesive layer and the lower ultraviolet adhesive layer respectively and near to the light incident surface of the base material layer.

3. The light guide film of claim 2, wherein the light incident microstructure unit comprises:
a plurality of microstructures, wherein each of the microstructures within the first microstructure region has a first depth, and each of the microstructures within the second microstructure region has a second depth, wherein the first depth is larger than the second depth.

4. The light guide film of claim 1, wherein a refractive index of the base material layer is larger than a refractive index of the lower ultraviolet adhesive layer, and a difference in between is D1.

5. The light guide film of claim 4, wherein an absolute difference between the refractive index of the lower ultraviolet adhesive layer and a refractive index of the optical adhesive layer near to the lower ultraviolet adhesive layer is D2, wherein the absolute difference satisfies an inequality: 0≤D2<D1.

6. The light guide film of claim 1, wherein a refractive index of the base material layer is smaller than a refractive index of the upper ultraviolet adhesive layer.

7. The light guide film of claim 1, wherein a refractive index of the base material layer is equal to a refractive index of the upper ultraviolet adhesive layer.

8. The light guide film of claim 1, wherein a refractive index of the lower ultraviolet adhesive layer is smaller than a refractive index of the upper ultraviolet adhesive layer.

9. The light guide film of claim 1, wherein the lower ultraviolet adhesive layer comprises:
an inclined part; and
a flat part, wherein the inclined part is near to the light incident surface of the base material layer, and the flat part extends from the inclined part in a direction away from the light incident surface of the base material layer.

10. A front light module, comprising:
the light guide film of claim 1, and the upper ultraviolet adhesive layer of the light guide film comprises a plurality of reflective microstructures; and
a light emitting unit disposed opposite to a light incident side of light guide film.

11. A reflective display, comprising:
the front light module of claim 10;
an optical component disposed above the light guide film; and
a reflective display panel disposed below the light guide film.

12. The reflective display of claim 11, wherein the optical component is a touch sensor.
